(19) United States
(12) Patent Application Publication
(10) Pub. No.: US 2020/0193364 A1
(43) Pub. Date: Jun. 18, 2020

(54) EQUIPMENT MANAGEMENT SYSTEM AND METHOD

(71) Applicant: Draeger Medical Systems, Inc., Andover, MA (US)

(72) Inventors: Richard Alexander WILSON, JR., Friendswood, TX (US); Andrew P. DICKEN, Branson West, MO (US); Brad REKUC, Chandler, AZ (US)

(21) Appl. No.: 16/711,980

(22) Filed: Dec. 12, 2019

Related U.S. Application Data
(60) Provisional application No. 62/778,551, filed on Dec. 12, 2018.

(51) Int. Cl. G06Q 10/08; G06F 21/31

(52) U.S. Cl. CPC G06Q 10/087; G06F 21/31

(57) ABSTRACT

An equipment management system is provided for use in a facility having an inventory of items. The system includes an inventory database, a user database, a person identification system and an inventory management system. The inventory database has inventory data stored therein, wherein the inventory data corresponds to the items of the inventory. The user database has user data stored therein, wherein the user data corresponding to an identity of a user. The person identification system generates a user identification signal based on a detected biometric parameter of the user and based on a detected non-biometric parameter associated with the user. The inventory management system generates an inventory identification signal based on a determination as to whether the user has removed an item of the inventory of items.

### TECHNICAL FIELD

Aspects of the present disclosure relate to systems and methods for managing equipment in a facility at a worksite.

### BACKGROUND

Worksites in many industries require storage and management of equipment. Conventionally, worksites include a staffed equipment room in which an operator of the equipment room manually distributes equipment to craftsmen who perform procedures at the worksite. However, manual distribution of equipment requires significant time from both the craftsmen and the operator of the equipment room.

For example, at the start of a shift at a worksite, a craftsman is required to approach and interact with the operator of the equipment room to receive any equipment needed to perform required procedures during her shift, verify that she has received the correct equipment, and ensure that any received equipment is properly calibrated before starting her required procedures during her shift. This leads to significant time loss at the beginning of the craftsman's shift, and as a result, a decrease in productivity of the craftsman.

Similarly, since a worksite may employ a large number of craftsmen, the operator must spend a significant amount of time interacting with the craftsmen and verifying their identity, verifying the correct equipment to be distributed to each of the craftsmen based on their respective procedures to be performed, retrieving and distributing equipment from the equipment room to the craftsmen, and keeping a record of equipment distributed and/or returned by the craftsmen in order to maintain an accurate inventory of the equipment room. In addition to the significant time required to perform manual distribution of equipment, the distribution of equipment can only be realized when an operator is staffing the equipment room.

### SUMMARY

Automated distribution of equipment has been proposed in order to reduce the time necessary for a craftsman to obtain equipment at the start of a shift, and to allow the operator of the equipment room to be reassigned to a different responsibility at the worksite to increase productivity at the worksite. Additionally, automated distribution of equipment would allow equipment to be distributed even when an operator is not staffing the equipment room.

However, automation of the distribution of equipment requires a system that can automatically perform the functions of an operator staffing the room, e.g., interacting with a craftsman and verifying her identity, verifying the correct equipment to be distributed to the craftsman based on a procedure to be performed, distributing equipment to the craftsmen, and keeping a record of equipment distributed and/or returned by the craftsman in order to maintain an accurate inventory of the equipment room. Accordingly, there exists a need in the art for a system that can automate these functions.

According to an aspect of the present disclosure, an equipment management system is for use in a facility having an inventory of items is provided. The equipment management system includes an inventory database operable to have inventory data stored therein, the inventory data corresponding to the items of the inventory, and a user database operable to have user data stored therein, the user data corresponding to an identity of a user. The equipment management system further includes a person identification system operable generate a user identification signal based on a detected biometric parameter of the user and based on a detected non-biometric parameter associated with the user, and an inventory management system operable generate an inventory identification signal based on a determination as to whether the user has removed an item of the inventory of items.

According to another aspect of the present disclosure, a method of an equipment management system for use in a facility having an inventory of items is provided. The method includes storing, in an inventory database, inventory data corresponding to the items of the inventory, and storing, in a user database, user data corresponding to an identity of a user. The method further includes detecting, via a person identification system, a detected biometric parameter of the user, detecting, via the person identification system, a detected non-biometric parameter associated with the user, and generating, via the person identification system, a user identification signal based on the detected biometric parameter of the user and based on the detected non-biometric parameter associated with the user. Additionally, the method includes determining, via an inventory management system, whether the user has removed an item of the inventory of items, and generating, via the inventory management system, an inventory identification signal based on the determination as to whether the user has removed the item of the inventory of items.

### BRIEF SUMMARY OF THE DRAWINGS

The accompanying drawings, which are incorporated in and form a part of the specification, illustrate example aspects of the disclosure and, together with the description, serve to explain the principles of the present disclosure. In the drawings:

FIG. 1 illustrates a facility for housing inventory to be disposed at a location where the inventory will be used;

FIG. 2 illustrates inventory and inventory storage that may be disposed in the facility of FIG. 1;

FIG. 3 illustrates an exemplary equipment management system for managing equipment in accordance with aspects of the present disclosure;

FIG. 4 illustrates a block diagram of an equipment management system in accordance with aspects of the present disclosure.

FIG. 5 illustrates a block diagram of a user database included in a database of the equipment management system of FIG. 4.

FIG. 6 illustrates a block diagram of a user data portion included in the user database of FIG. 5.

FIG. 7 illustrates a block diagram of a person identification system included in the equipment management system of FIG. 4.

FIG. 8 illustrates an exemplary method for managing equipment using the equipment management system of FIG. 4 in accordance with an aspect of the present disclosure.

FIG. 9 illustrates an exemplary method of inventory processing performed by an inventory management system included in the equipment management system of FIG. 4 according to an aspect of the present disclosure.

FIG. 10 illustrates an exemplary method for managing equipment using the equipment management system of FIG. 4 in accordance with an aspect of the present disclosure.

FIG. 11 illustrates an exemplary method for managing equipment using the equipment management system of FIG. 4 in accordance with an aspect of the present disclosure.

FIG. 12 illustrates an exemplary method for managing equipment using the equipment management system of FIG. 4 in accordance with an aspect of the present disclosure.

### DETAILED DESCRIPTION

The following detailed description is provided to gain a comprehensive understanding of the methods, apparatuses, and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

The present disclosure may, however, be embodied in many different forms and should not be construed as limited to the aspects of the disclosure set forth herein. Rather, these exemplary aspects of the disclosure are provided so that this disclosure is thorough, and will fully convey the scope of the invention to those skilled in the art.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Further, it will be understood that when an element is referred to as being “connected to” another element, it can be directly connected to the other element, or intervening elements may be present. The terminology used herein is for the purpose of describing particular aspects of the disclosure only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item.

An example of an automated system for distributing equipment is a rental robot. A rental robot is a system of secure lockers from which users, such as craftsmen at the worksite, may check out equipment necessary to perform procedures at the worksite. The rental robot may be set up wherever needed at a worksite and the secure lockers of the rental robot may be configured in different configurations and/or different sizes to suit specific storage requirements of the equipment according to the needs of the worksite. The rental robot is typically paired with a controlling unit, which manages access to the secure lockers.

The controlling unit of the rental robot is able to grant an authorized user access to a secure locker, nevertheless, it is important to verify the identity of a user prior to enabling access to the equipment stored in the secured lockers. The controlling unit of the rental robot may employ conventional systems, such as a magnetic badge or card reader, but such conventional systems may be spoofed when an unauthorized person gains access to such a badge or card, (e.g., via theft of a badge or through workers accidentally swapping badges), thereby creating a situation where an unauthorized person is then able to be granted access to a secure locker by the controlling unit of the rental robot.

In general, it is important to ensure that the identities of the user are verified prior to providing access to equipment to ensure that the users (e.g., craftsmen or workers) are provided all the equipment they need in order to perform their work. Likewise, it is important to ensure that the identities of the craftsmen are verified to ensure that the craftsmen are not provided the wrong equipment for the job they are assigned, equipment they do not need (thus preventing other workers from accessing the equipment), or equipment they are not trained to use. The use of an equipment to which the user is not authorized or properly trained could potentially create an unsafe situation for the user and/or others around the user.

Further, it would also be advantageous for the rental robot to ensure that the user is not impaired before granting the user access to the equipment. Such impairment may create an unsafe environment for the user and/or others around the user if the user is granted access to equipment and begins work while under the influence of alcohol or a controlled substance.

In order to solve one or more of the aforementioned problems, one purpose of the present disclosure is to verify the identification of a user using one or more biometric parameters, one or more non-biometric parameters, or a combination thereof, in order to decrease the likelihood of an incorrect identification of the user and/or spoofing of identifying information of the user.

In order to solve one or more of the aforementioned problems, one purpose of the present disclosure is to automatically determine whether a user has removed or replaced a correct inventory item and whether the user has removed or replaced all of the required inventory items based on a procedure to be performed by the user. Accordingly, an aspect of the present disclosure is able to alert the user and/or others if the user does not remove or replace the correct inventory and/or the user does not remove or replace all of the required inventory items based on a procedure to be performed by the user.

In order to solve one or more of the aforementioned problems, one purpose of the present disclosure is to require that the user undergo an impairment check prior to the removal of an inventory item and/or undergo an impairment check prior to entering the work environment after removing the inventory item. Accordingly, an aspect of the present disclosure is able to alert the user and/or others if the user is impaired by alcohol or a controlled substance.

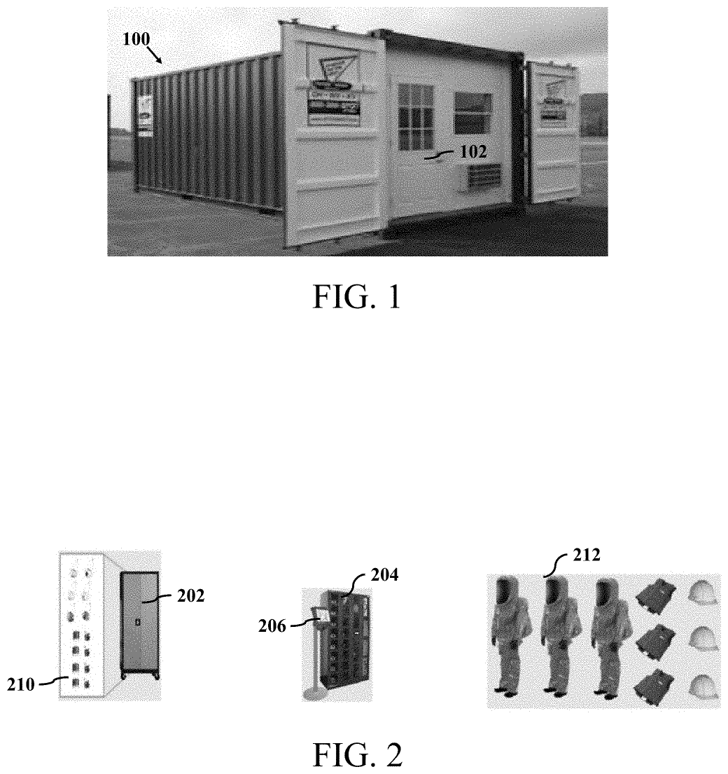

FIG. 1 illustrates a facility 100 for housing inventory to be disposed at a location where the inventory (e.g., equipment) will be used. The facility 100 may be a permanent structure located at the location or a temporary structure, such as a trailer, located at the location. The location may be a worksite, where the inventory within facility 100 will be used by employees at the worksite. The worksite is any location where work is performed in an industry that may benefit from the present disclosure. Non-limiting examples of industry that may benefit from the present disclosure include fire services, chemical industry, oil and gas industry, mining, water treatment, food and beverage industry, and pharmaceutical industry.

A person may enter door 102 of facility 100 at a worksite to obtain equipment or materials to perform a job at the worksite. Once in facility 100, the person may take non-returnable inventory or returnable inventory from the examples of inventory storage described below.

FIG. 2 illustrates non-limiting examples of inventory storage that may be disposed in facility 100.

In this regard, FIG. 2 illustrates a non-returnable inventory storage unit 202 for storing a plurality of non-returnable inventory items 210 as described below, a returnable inventory rental robot unit 204 for storing returnable inventory items 212 as described below, and a rental robot controlling unit 206 for monitoring the returnable inventory of returnable inventory rental robot unit 204.

Non-returnable inventory storage unit 202 stores a plurality of non-returnable inventory items 210. Non-returnable inventory storage unit 202 may be any device that is capable of storing multiple items of non-returnable inventory, enable users to retrieve items of the non-returnable inventory and enable users to restock items of the non-returnable inventory. A non-limiting example of non-returnable inventory storage unit 202 is a locker, a chest, a closet, a shelf, a cubby, and the like.

Non-returnable inventory items 210 stored in the non-returnable inventory storage unit 202 are items that are not to be returned for future use. Non-limiting examples of non-returnable inventory items 210 include single-use items including: consumable items such as food, medication, fuel, etc.; building materials such as wood, brick, concrete mixture, etc.; disposable items such as paper or cloth facemasks, filters, paper or cloth shoe coverings, latex gloves, etc.; and the like.

Returnable inventory rental robot unit 204 stores returnable inventory items 212. Returnable inventory rental robot unit 204 may be any device or systems that are capable of storing multiple items of returnable inventory, automatically retrieve items of the returnable inventory for users, and enable users to return the removed items of the returnable inventory.

Returnable inventory items 212 are items that are to be returned for future use. Non-limiting examples of returnable inventory items 212 may include equipment such as gas detection devices, calibration devices, measurements devices, and the like, and wearable gear such as chemical protective suits, protective eyewear, gloves, boots, safety harnesses, hearing protection, breathing apparatuses, air tanks, and the like.

Non-returnable inventory items 210 and returnable inventory items 212 may additionally be tagged with radio frequency identification (RFID) stickers. In this regard, tagging non-returnable inventory items 210 and returnable inventory items 212 with RFID stickers may be useful in any situation of controlled entry, where specific equipment “outfitting” of a user would be helpful. For example, in a confined space entry scenario—such as entering a storage tank to conduct inspections and/or make repairs, going down into a manhole/sewer, etc., RFID scanning, which can be performed upon user entry to and/or exit from facility 100, can check for the appropriate equipment being worn and then automatically check in/check out the user in a worker tracking/logging system. As an additional feature, the RFID scanning can also get real-time operational status of the personal protection equipment prior to entry to confirm device readiness, non-limiting examples of real-time operational status including level of gas in air tanks, battery change of portable gas detectors, battery change of portable calibration devices, battery change of portable measurement devices, and the like.

Rental robot controlling unit 206 may be any device or system that is capable of monitoring the returnable inventory of returnable inventory rental robot unit 204. Rental robot controlling unit 206 may be able to perform the following functions: locking returnable inventory rental robot unit 204 to prevent users from removing any returnable inventory; unlocking returnable inventory rental robot unit 204 to enable users to remove returnable inventory; track a day and time of removal of a returnable inventory item when removed from returnable inventory rental robot unit 204; track a day and time of replacement of a previously-removed returnable inventory item when removed from returnable inventory rental robot unit 204. Recording this information may be useful in tracking device usage. For example, some equipment may need periodic maintenance after a certain number of uses, or length of the usage. The rental robot controlling unit 206 would be able to track the number of times a reusable/returnable inventory has been used. Likewise, some equipment may need to be cleaned or sterilized after its use. The rental robot controlling unit 206 could ensure that the equipment is not made available to the next user until it has been properly cleaned or serviced. Similarly, upon return of such equipment, an alert or notification could be provided to the employee responsible for the cleaning or service of the equipment.

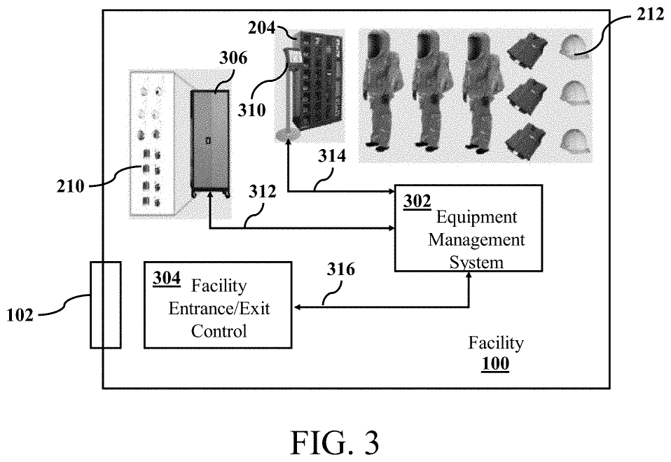

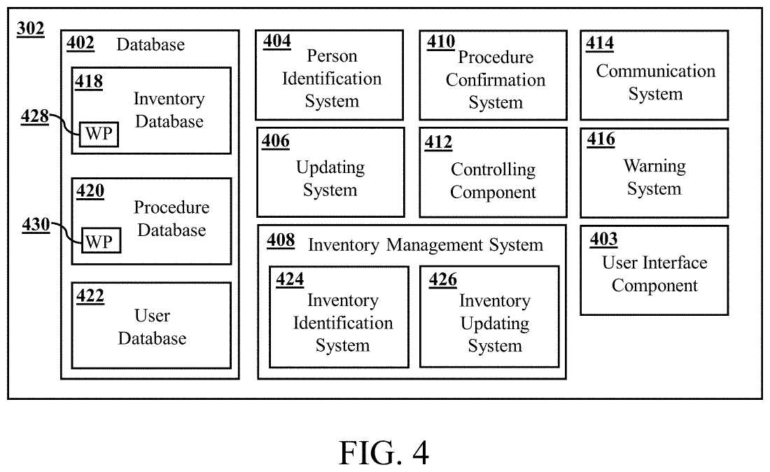

FIG. 3 illustrates an example system for managing equipment in accordance with aspects of the present disclosure.

As illustrated in FIG. 3, facility 100 includes an equipment management system 302 for managing equipment, a facility entrance/exit control 304 for managing entry into facility 100 and exit from facility 100, a non-returnable inventory storage unit 306 for storing items of non-returnable inventory, a returnable inventory rental robot unit 204 for storing items of returnable inventory, and a rental robot controlling unit 310 for monitoring the returnable inventory stored in the returnable inventory rental robot unit 204.

Equipment management system 302 is arranged to communicate with inventory storage unit 306 via a communication channel 312. For example, the communication between equipment management system 302 and inventory storage unit 302 includes information and/or commands related to the items of the non-returnable inventory stored by inventory storage unit 302.

Additionally, equipment management system 302 is arranged to communicate with rental robot controlling unit 310 via a communication channel 314. For example, the communication between equipment management system 302 and rental robot controlling unit 310 includes information and/or commands related to the items of the returnable inventory stored by rental robot unit 204.

Further, equipment management system 302 to communicate with facility entrance/exit control 304 via a communication channel 316. For example, the communication between equipment management system 302 and facility entrance/exit control 304 includes information and/or commands managing entry into facility 100 and exit from facility 100.

Each of communication channel 312, communication channel 314, and communication channel 316 may be any known type of communication channel, non-limiting examples of which include wired communication channels such as coaxial cable and fiber-optic link to allow communication via Ethernet, and wireless communication channels such as wireless network (IEEE 802.XX), cellular data service (3G/4G/5G), and short-range communication technologies (e.g., Bluetooth, RFID, NFC, Zigbee).

Equipment management system 302 manages equipment in accordance with aspects of the present disclosure. Equipment management system 302 may be any device system that is capable of managing equipment as described later with respect to FIGS. 4-12.

Facility entrance/exit control 304 may be any device or system that is capable of managing entry into facility 100 and exit from facility 100. Non-limiting example functions of facility entrance/exit control 304 include locking and unlocking of door 102 and time stamping entry and exit from facility 100 through door 102. Facility entrance/exit control 304 is further capable of providing data related to entry and exit from facility 100 through door 102 to equipment management system 302 via communication channel 316.

Inventory storage unit 306 is a modified version of non-returnable inventory storage unit 202 discussed above with reference to FIG. 2. More specifically, in addition to performing the above-described functions of non-returnable inventory storage unit 202, inventory storage unit 306 is further operable to monitor: the current stock of the non-returnable inventory; the stocking of the non-returnable inventory; the removal of the non-returnable inventory, and the amount of available space for additional stock.

Rental robot controlling unit 310 is a modified version of rental robot controlling unit 206 discussed above with reference to FIG. 2, More specifically, in addition to performing the above-described functions of rental robot controlling unit 206, rental robot controlling unit 310 is further capable of providing information related to the returnable inventory to equipment management system 302 via communication channel 314. Further, in some aspects of the disclosure, rental robot controlling unit 310 is additionally capable of monitoring the charge and/or calibration of certain items of returnable inventory, such as gas detection devices, measurement devices, and calibration devices.

For example, in cases where an item of returnable inventory has a power source or an amount of fuel that is measurable by the inventory item, the amount of power or fuel in the inventory item may be monitored by rental robot controlling unit 310. Such non-limiting examples include an amount of battery charge or an amount of fuel in a piece of equipment. Such a remaining charge of the item of returnable inventory may additionally be provided to equipment management system 302.

In this regard, returnable inventory rental robot unit 204 may be configured to include a charging station in order to charge used equipment returned to returnable inventory rental robot unit 204 in order to ensure that, when the equipment is next removed, the equipment will be fully charged (or, for example, may prevent removal of the equipment, if the equipment lacks sufficient charge), and returnable inventory rental robot unit 204 may be configured to include a calibration dock that calibrates used equipment returned to returnable inventory rental robot unit 204 in order to ensure that, when the equipment is next removed, the equipment will be calibrated. Further, rental robot controlling unit 310 is operable to provide information related to the non-returnable inventory to equipment management system 302 via communication channel 312.

FIG. 4 illustrates a block diagram of equipment management system 302 of FIG. 3.

As shown in FIG. 4, equipment management system 302 includes a database 402 for storing data necessary for equipment management system 302 to manage equipment, a user interface (UI) component 403 for enabling input of user data to the equipment management system 302, a person identification system 404 for performing an action to identify a person that is attempting to gain entry into facility 100, an updating system 406 for updating data stored in database 402, an inventory management system 408 for managing inventory data stored in database 402, a procedure confirmation system 410 for confirming whether a required procedure has been performed, a controlling component 412 for controlling the components of the equipment management system 302, a communication system 414 for enabling equipment management system 302 to perform communication, and a warning system 416 for generating and issuing a warning as appropriate.

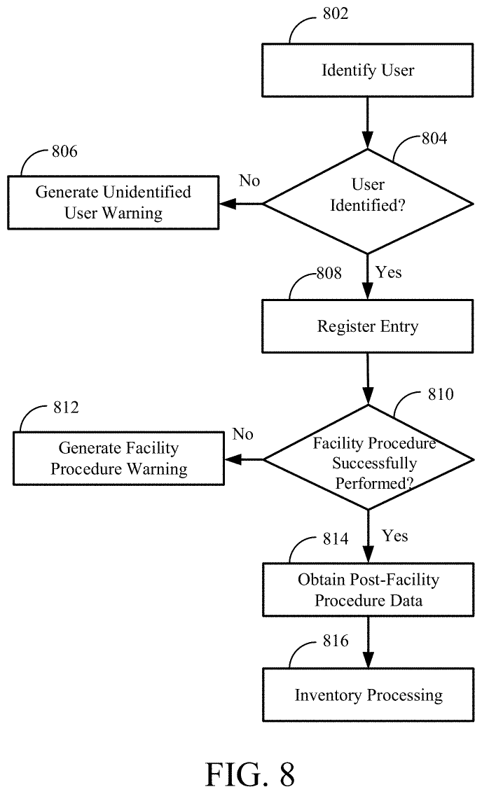

Database 402 is provided for storing data necessary for the equipment management system 302 to manage equipment in accordance with the exemplary methods for managing equipment using the equipment management system 302 as described below with reference to FIGS. 8-12. Database 402 may be any device or system that is capable of managing the storage, retrieval, deletion and modification of data in accordance with aspects of the present disclosure. Non-limiting examples of database 402 include memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer.

According to an aspect of the present disclosure, database 402 further includes an inventory database 418 for storing inventory data related to items stored in inventory, a procedure database 420 for storing procedural data related to a procedure to be performed by a user, and a user database 422 for storing data for identifying a user.

According to the aspect of the present disclosure illustrated in FIG. 4, inventory database 418, procedure database 420, and user database 422 are illustrated as individual devices. However, the present disclosure is not limited to such an arrangement. For example, two or more of inventory database 418, procedure database 420, and user database 422 may be combined into a single device. Further, in some aspects of the present disclosure, at least one of inventory database 418, procedure database 420, and user database 422 may be implemented as a computer having tangible computer-readable media for carrying or having computer-executable instructions or data structures stored thereon.

Inventory database 418 stores information of specific inventory items associated with procedures that may be performed. Non-limiting examples of the information of the specific inventory items include stock level, type, working condition, e.g., functional or defective, battery level, use life, estimated remaining shelf life, and the like. Non-limiting examples of specific inventory items include the following; gas detection devices; calibration devices; measurements devices; goggles; face shield; gloves, e.g., leather, chemical resistant, electrical resistant; a hood, e.g., chemical resistant, thermal resistant, welding, blasting; a suit, e.g., chemical resistant, thermal resistant, Tyvek; boots, e.g., chemical resistant, rubber, thermal; safety harness, e.g., lanyard, self-retracting lifeline; hearing protection, e.g., single or double; air purifying respirator and type; supplied air respirator; airline respirator with egress; and SCBA (Self-Contained Breathing Apparatus).

Examples of procedural data stored in the procedure database 420 related to a procedure to be performed by a user may include the following: facility procedure data that corresponds to a facility procedure to be performed by the user prior to leaving the facility; and post-facility procedure data that corresponds to a post-facility procedure to be performed by the user after leaving the facility and to a post-facility procedure item of the inventory of items that is required for the user to perform the post-facility procedure. Additionally, the facility procedure data may include information indicating one or more actions that the user is required to perform and one or more conditions that must be met for each of the one or more actions in order for the facility procedure to be successfully performed. For example, the facility procedure data may indicate that the user is required to take an action of performing a breathalyzer test to verify that a blood alcohol level is below a predefined level, that the user is required to take an action of performing a test to verify that an amount of a controlled substance present in the user is below a predefined level, or the like.

Additionally, inventory database 418 includes a warning portion 428 for storing data associated with detecting and generating warnings related to inventory, and procedure database includes a warning portion 430 for detecting and generating warnings related to procedures.

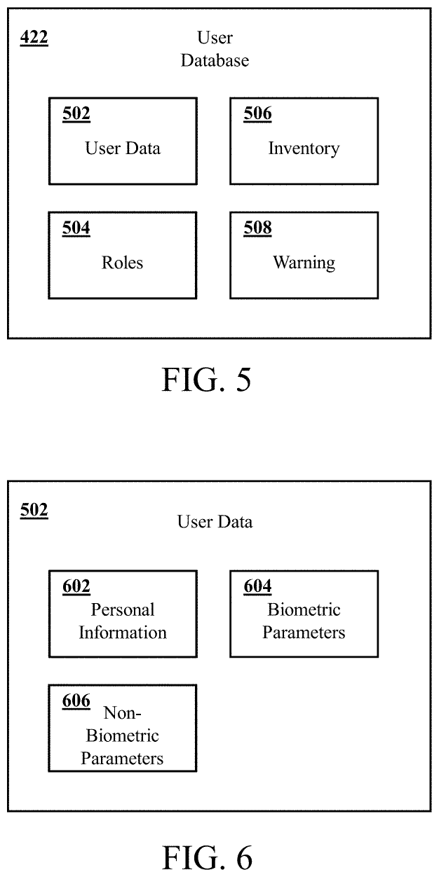

Non-limiting examples of data for identifying a user stored in the user database 422 may include personal information of the user, biometric parameter information of the user, and non-biometric information of the user. Further description of this information will be described below with reference to FIGS. 5 and 6.

UI component 403 enables input of user data to the equipment management system 302 and output of information from the equipment management system 302 to the user in accordance with the exemplary methods for managing equipment using the equipment management system 302 as described below with reference to FIGS. 8-12. UI component 403 may be any device or system that enables a user to access and control the equipment management system 302 in accordance with aspects of the present disclosure. For example, UI component 403 may include one or more layers including a human-machine interface (HMI) machines with physical input hardware such a keyboards, mice, game pads and output hardware such as computer monitors, speakers, and printers. Additional UI layers in UI component 403 may interact with one or more human senses, including: tactile UI (touch), visual UI (sight), and auditory UI (sound).

Person identification system 404 performs an action to identify a person that is attempting to gain entry into facility 100 in accordance with the exemplary methods for managing equipment using the equipment management system 302 as described below with reference to FIGS. 8-12. Person identification system 404 may be any device or system that is capable of performing an action to identify a person that is attempting to gain entry into facility 100 based on inputted user data and data stored in the database 402 an action to identify a person that is attempting to gain entry into facility 100.

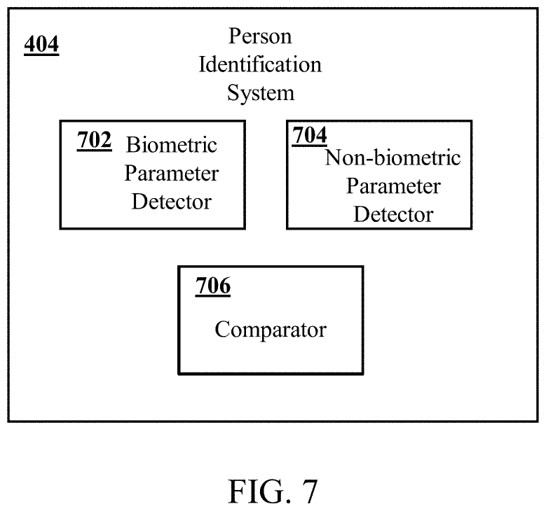

For example, person identification system 404 may be any device or system that is capable of obtaining at least one of biometric parameter data and non-biometric parameter data. Biometric parameter data may be obtained by known biometric recording systems and may include, but are not limited to, fingerprint, hand print, facial image, vocal sample, iris image, retinal image, fundus image. Non-biometric parameter data may be obtained by an RFID system operable to detect an RFID tag associated with a user. Further details of person identification system 404 are illustrated in FIG. 7 described below.

Updating system 406 updates data stored in database 402 in accordance with the exemplary methods for managing equipment using the equipment management system 302 as described below with reference to FIGS. 8-12. Updating system 406 may be any device or system that is capable of instructing database 402 to update data stored therein in accordance with aspects of the present disclosure. For example, updating system 406 updates the user database 422 upon identification and registration of a user, as described below in reference to FIG. 8.

Inventory management system 408 manages inventory data stored in inventory database 418 of database 402 in accordance with the exemplary methods for managing equipment using the equipment management system 302 as described below with reference to FIGS. 8-12. Inventory management system 408 may be any device or system that is capable of enabling management of the inventory data stored in inventory database 418 of database 402 in accordance with aspects of the present disclosure.

According to an aspect of the present disclosure, inventory management system 408 includes an inventory identification system 424 operable to determine whether a user has removed or replaced one or more inventory items as appropriate and an inventory updating system 426 operable to cause the inventory data stored in inventory database 418 to be updated when a user has removed or replaced one or more items of the inventory.

According to the aspect of the present disclosure illustrated in FIG. 4, inventory identification system 424 and inventory updating system 426 are illustrated as individual devices. However, the present disclosure is not limited to such an arrangement. For example, inventory identification system 424 and inventory updating system 426 may be combined into a single device. Further, in some aspects of the present disclosure, at least one of inventory identification system 424 and inventory updating system 426 may be implemented as a computer having tangible computer-readable media for carrying or having computer-executable instructions or data structures stored thereon.

Procedure confirmation system 410 confirms whether a required procedure has been performed in accordance with the exemplary methods for managing equipment using the equipment management system 302 as described below with reference to FIGS. 8-12. Procedure confirmation system 410 may be any device or system that is capable of accessing procedure database 420 of database 402 and determining what procedures are necessary to be performed in accordance with aspects of the present disclosure.

Controlling component 412 controls the components of the equipment management system 302 in accordance with the exemplary methods for managing equipment using the equipment management system 302 as described below with reference to FIGS. 8-12. Controlling component 412 may be any device or system that is capable of controlling the operation of database 402, person identification system 404, updating system 406, inventory management system 408, procedure confirmation system 410, communication system 414, and warning system 416 in accordance with aspects of the present disclosure.

Communication system 414 enables equipment management system 302 to perform communication in accordance with the exemplary methods for managing equipment using the equipment management system 302 as described below with reference to FIGS. 8-12.

Communication system 414 may be any device or system that is capable of enabling equipment management system 302 to communicate with inventory storage unit 306 via communication channel 312, communicate with rental robot controlling unit 310 via a communication channel 314, and communicate with facility entrance/exit control 304 via communication channel 316 in accordance with aspects of the present disclosure.

For example, in accordance with an aspect of the present disclosure, communication system 414 may receive non-returnable inventory data associated with the non-returnable inventory stored and/or provided in inventory storage unit 306 as provided by inventory storage unit 306, receive returnable inventory data associated with the returnable inventory stored in returnable inventory rental robot unit 204 as provided by rental robot controlling unit 310, and receive data related to entry and exit from facility 100 through door 102 as provided by facility entrance/exit control 304.

The non-returnable inventory data provided by the inventory storage unit 306 is data formatted to: identify an inventory item stored and/or provided in inventory storage unit 306 and/or indicate removal of an inventory item stored and/or provided in inventory storage unit 306; and identify the removal of an inventory item from inventory storage unit 306.

The returnable inventory data provided by the rental robot controlling unit 310 is data formatted to: identify an inventory item stored and/or provided in returnable inventory rental robot unit and/or indicate removal or replacement of an inventory item stored and/or provided in returnable inventory rental robot unit 204; and to identify the removal or replacement of an inventory item from returnable inventory rental robot unit 204.

Upon receipt of any received non-returnable inventory removal signal including the non-returnable inventory data, returnable inventory removal signal including the returnable inventory data, or returned inventory signal including the returnable inventory data by communication system 414, controlling component 412 then provides any of the received signals to inventory management system 408. In response to receiving any of the signals, inventory updating system 426 then instructs inventory database 418 to update the inventory in accordance with the information as appropriate. In this manner, inventory database 418 maintains a current inventory of non-returnable inventory items 210 in non-returnable inventory storage unit 306 and returnable inventory items 212 from returnable inventory rental robot unit 204.

Warning system 416 generates and issues a warning as appropriate in accordance with the exemplary methods for managing equipment using the equipment management system 302 as described below with reference to FIGS. 8-12. Warning system 416 may be any device or system that is capable of generating a warning based one or more of an unapproved user warning, a facility procedure failure warning, and an inventory warning in accordance with aspects of the present disclosure. By way of non-limiting example, warning system 416 is capable of generating a warning based on an unapproved user gaining entry into facility 100, a user leaving the facility 100 without performing a required facility procedure, a user removing an unauthorized inventory item, a user replacing an incorrect inventory item, a user failing to remove a required inventory item. Further, warning system 416 may instruct communication system 414 to send a text message, send an email, send a prerecorded telephone message to the manager of facility 100, and combinations thereof, indicating the basis for the warning. Alternatively, a user may be able to remotely access the equipment management system to view the status of the system and various equipment being managed.

According to the aspect of the present disclosure illustrated in FIG. 4, database 402, UI component 403, person identification system 404, updating system 406, inventory management system 408, procedure confirmation system 410, controlling component 412, communication system 414, and warning system 416 are illustrated as individual devices. However, the present disclosure is not limited to such an aspect. In some aspects of the present disclosure, at least two of database 402, UI component 403, person identification system 404, updating system 406, inventory management system 408, procedure confirmation system 410, controlling component 412, communication system 414, and warning system 416 may be combined as a unitary device. Further, in some aspects of the present disclosure, at least one of database 402, UI component 403, person identification system 404, updating system 406, inventory management system 408, procedure confirmation system 410, controlling component 412, communication system 414, and warning system 416 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from, and write information to the tangible computer-readable media. In the alternative, the tangible computer-readable media may be integral to the processor. The processor and the tangible computer-readable media may reside in an application specific integrated circuit (“ASIC”). In the alternative, the processor and the tangible computer-readable media may reside as discrete components.

Example tangible computer-readable media may be also be coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

A program/utility, having a set (at least one) of program modules, may be stored in the memory by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various aspects of the present disclosure as described herein.

FIG. 5 illustrates a block diagram of user database 422 included in the database 402 of FIG. 4.

As shown in FIG. 5, user database 422 includes a user data portion 502 for storing user data related to registered users of facility 100, a roles portion 504 for storing data related to roles associated with registered users of facility 100, an inventory portion 506 for storing inventory data of inventory items associated with registered users of facility 100, and a warning portion 508 for storing warning instructions data associated with registered users of facility 100 and warning instructions data associated with unapproved users of facility 100.

User data portion 502 is capable of having stored therein, managing, and retrieving therefrom, user data related to registered users of facility 100. Description of the data stored in user data portion 502 will be described later with reference to FIG. 6.

Roles portion 504 is capable of having stored therein, managing, and retrieving therefrom, roles data related to roles associated with registered users of facility 100. The roles data may take any known form of data structure and may include, for every person that is registered in equipment management system 302, data fields including: a registered person name data field; a registered person role data field, indicating allotted roles, non-limiting examples of which include job descriptions; a facility procedure data field, indicating facility procedures associated with the role of the person that are required to be performed as indicated in procedure database 420; a post-facility procedure data field, indicating post-facility procedures associated with the role of the person that are required to be performed as indicated in procedure database 420; an approved inventory data field, indicating inventory associated with the role for which are approved to be removed; and a required inventory data field, indicating required inventory associated with the role for which are required to be removed.

Inventory portion 506 is capable of having stored therein, managing, and retrieving therefrom, inventory data of inventory items associated with registered users of facility 100. The inventory data may take any known form of data structure and may include, for every person that is registered in equipment management system 302, data fields including: a registered person name data field; and an approved inventory data field, indicating inventory for which are approved to be removed.

Warning portion 508 is capable of having stored therein, managing, and retrieving therefrom, warning instructions data associated with registered users of facility 100 and warning instructions data associated with unapproved users of facility 100.

The warning instructions data for registered users are used when registered users are using the facility. The warning instructions data for registered users may take any known form of data structure and may include, for person that is registered in equipment management system 302, data fields including: a warning trigger data field, indicating an action that would trigger a warning, non-limiting examples of which include removal by an unauthorized person, removal of an uncharged (depleted) inventory item, incorrect replacement of the item into returnable inventory rental robot unit 204; a warning contact data field, indicating a person (or persons) to contact in the event of a warning trigger, a non-limiting example of which includes a manager of facility 100; and a warning type data field, indicating the type of warning to generate, non-limiting examples of which include, sounding a siren, flashing a light, transmitting a prerecorded telephone message, transmitting an email, transmitting a text message and combinations thereof.

The warning instructions data for unapproved users are used when unapproved users are using the facility. The warning instructions data for unapproved users may take any known form of data structure and may include data fields including: entry into facility 100; a warning contact data field, indicating a person (or persons) to contact in the event of a warning trigger, non-limiting examples of which include a manager of facility 100 and a law enforcement agency; and a warning type data field, indicating the type of warning to generate, non-limiting examples of which include, sounding a siren, flashing a light, transmitting a prerecorded telephone message, transmitting an email, transmitting a text message and combinations thereof.

According to the aspect of the present disclosure illustrated in FIG. 5, user data portion 502, roles portion 504, inventor portion 506, and warning portion 508 are illustrated as individual devices. However, the present disclosure is not limited to such an arrangement. For example, two or more of user data portion 502, roles portion 504, inventor portion 506, and warning portion 508 may be combined into a single device. Further, in some aspects of the present disclosure, at least one of user data portion 502, roles portion 504, inventor portion 506, and warning portion 508 may be implemented as a computer having tangible computer-readable media for carrying or having computer-executable instructions or data structures stored thereon.

FIG. 6 illustrates a block diagram of user data portion 502 illustrated in FIG. 5.

As illustrated in FIG. 6, user data portion 502 includes personal information portion 602 for storing personal information of registered users of the facility 100, biometric parameters portion 604 for storing biometric parameter data of registered users of the facility 100, and non-biometric parameters portion 606 for storing non-biometric parameter data of registered users of the facility 100.

Personal information portion 602 is capable of having stored therein, managing, and retrieving therefrom, personal information of registered users of the facility 100. The personal information may take any known form of data structure and may include, for each person that is registered in equipment management system 302, data fields including: a registered person name data field; a registered person contact information data field, indicating for example, the telephone or email address of the registered person; an immediate supervisor data field, indicating the immediate supervisor of the registered person; an immediate supervisor contact data field, indicating, for example, the telephone or email address of the immediate supervisor of the registered person.

Biometric parameters portion 604 is capable of having stored therein, managing, and retrieving therefrom, biometric parameter data of registered users of the facility 100. The biometric parameter data may take any known form of data structure and may include, for each person that is registered in equipment management system 302, a data field for each biometric parameter that is associated with the person, non-limiting examples of which include fingerprint, a hand print, a face image, a vocal sample, an iris image, a retinal image, a fundus image and combinations thereof. These data fields may be populated using person identification system 404, for example by inputting an initial scan of the person's fingerprint, hand print, face image, vocal sample, iris image, retinal image or fundus image using known biometric recording systems.

Non-biometric parameters portion 606 is capable of having stored therein, managing, and retrieving therefrom, non-biometric parameter data of registered users of the facility 100. The non-biometric parameter data may take any known form of data structure and may include, for each person that is registered in equipment management system 302, a data field for each non-biometric parameter that is associated with the person, a non-limiting example of which includes an RFID tag associated with a badge worn by the person. These data fields may be populated using UI component 403, for example by inputting data associated with the RFID tag of the person that is on a badge of the person.

According to the aspect of the present disclosure illustrated in FIG. 6, personal information portion 602, biometric parameters portion 604, and non-biometric parameters portion 606 are illustrated as individual portions. However, the present disclosure is not limited to such an arrangement. For example, two or more of personal information portion 602, biometric parameters portion 604, and non-biometric parameters portion 606 may be combined into a single device. Further, in some aspects of the present disclosure, at least one of personal information portion 602, biometric parameters portion 604, and non-biometric parameters portion 606 may be implemented as a computer having tangible computer-readable media for carrying or having computer-executable instructions or data structures stored thereon.

FIG. 7 illustrates a block diagram of person identification system 404 of FIG. 4.

As shown in FIG. 7, person identification system 404 includes a biometric parameter detector 702 for detecting a biometric parameter of a person, a non-biometric parameter detector 704 for detecting a non-biometric parameter of a person, and a comparator 706 for comparing a detected biometric/non-biometric parameter of a person with a corresponding parameter stored in user data portion 502 of database 422.

Biometric parameter detector 702 detects a biometric parameter of a person in accordance with the exemplary methods for managing equipment using the equipment management system 302 as described below with reference to FIGS. 8-12. Biometric parameter detector 702 may be any known device or system that is capable of detecting a biometric parameter of a person in accordance with aspects of the present disclosure. Non-limiting examples of biometric parameter detector 702 includes fingerprint detecting system operable to detect and record the image of a fingerprint of a person as fingerprint data, a hand print detecting system operable to detect and record an image of a hand print of a person as handprint data, a face image detecting system operable to detect and record an image of a face of a person as facial data, a vocal sample detecting system operable to detect and record a sound sample of the voice of a person as vocal sample data, an iris image detecting system operable to detect and record an image of the iris of a person as iris data and a fundus image detecting system operable to detect and record an image of a fundus of the eye of a person as fundus data.

Non-biometric parameter detector 704 detects a non-biometric parameter of a person in accordance with the exemplary methods for managing equipment using the equipment management system 302 as described below with reference to FIGS. 8-12. Non-biometric parameter detector 704 may be any device or system that is capable of detecting a non-biometric parameter of a person in accordance with aspects of the present disclosure. Non-limiting examples of non-biometric parameter detector 704 include an RFID detector capable of detecting an RFID signal from an RFID tag, which may be included, for example, in a badge of a person, a physical keyboard or touchscreen device capable of detecting a password or personal identification number (PIN) assigned to a person, and a touchscreen device capable of recognizing a keyboard entry pattern, such as a particular trace pattern, inputted by a person.

Comparator 706 compares a detected biometric/non-biometric parameter of a person with a corresponding parameter stored in user data portion 402 of database 422 in accordance with the exemplary methods for managing equipment using the equipment management system 302 as described below with reference to FIGS. 8-12. Comparator 706 may be any device or system that is capable of comparing a biometric parameter, as detected by biometric parameter detector 702, with a biometric parameter stored in biometric parameters portion 604 of user data portion 502 of user database 422 in accordance with aspects of the present disclosure. Further, comparator 706 may be any device or system that is capable of comparing a non-biometric parameter as detected by non-biometric parameter detector 704 with a non-biometric parameter stored in non-biometric parameters portion 606 of user data portion 502 of user database 422 in accordance with aspects of the present disclosure.

According to the aspect of the present disclosure illustrated in FIG. 7, biometric parameter detector 702, biometric parameter detector 704, and comparator 706 are illustrated as individual portions. However, the present disclosure is not limited to such an arrangement. For example, two or more of biometric parameter detector 702, biometric parameter detector 704, and comparator 706 may be combined into a single device. Further, in some aspects of the present disclosure, at least one of biometric parameter detector 702, biometric parameter detector 704, and comparator 706 may be implemented as a computer having tangible computer-readable media for carrying or having computer-executable instructions or data structures stored thereon.

FIGS. 8-12 illustrate exemplary methods for managing equipment using the equipment management system 302 according to aspects of the present disclosure. It should be understood that prior to the execution of the methods illustrated in FIGS. 8-12, relevant data will be populated into inventory database 418, procedure database 420, and user database 422 of database 402 included in equipment management system 302, as necessary, to perform the exemplary methods illustrated in FIGS. 8-12. Non-limiting examples of population of the data include single entry or batch entry of the relevant data using communication system 414 via wired communication channels such as coaxial cable and fiber-optic link to allow communication via Ethernet, wireless communication channels such as wireless network (IEEE 802.XX), cellular data service (3G/4G/5G), and short-range communication technologies (e.g., Bluetooth, RFID, NFC, Zigbee), or a combination thereof. Additionally, population of the data may be performed by direct entry of the relevant data by a person using UI component 403.

FIG. 8 illustrates an exemplary method for managing equipment using the equipment management system 302 according to an aspect of the present disclosure. More specifically, the method of FIG. 8 requires a user who has gained access to the facility 100 to undergo a facility procedure to demonstrate the user is not impaired prior to removal or replacement of inventory. Additionally, the aspect of the present disclosure illustrated in FIG. 8 contemplates that facility 100 stores different types of inventory items corresponding to different types of post-facility procedures to be performed.

At Step 802, a user is attempting to gain access to facility 100 and equipment management system 302 attempts to identify the user. In order to identify the user, equipment management system 302 detects one or more biometric parameters of the user using biometric parameter detector 702, one or more non-biometric parameters of the user using non-biometric parameter detector 704, or a combination thereof.

For the purposes of description of the exemplary method illustrated in FIG. 8, biometric parameter detector 702 is a system capable of facial recognition, the biometric parameter of the user is a facial image of the user attempting to gain entry to the facility 100, the non-biometric parameter detector 704 is an RFID system capable of detecting an RFID signal from an RFID tag included in a badge of the user attempting to gain entry to the facility 100, and the non-biometric parameter is the RFID data associated with the RFID signal.

Biometric parameter detector 702 sends the facial image of the user that is attempting to gain entry into facility 100 to comparator 706. Similarly, non-biometric parameter detector 704 sends RFID data associated with the RFID signal to comparator 706. Comparator 706 then compares the facial image and the RFID data with registered user data previously stored in the user database 422.

In this regard, person identification system 404 obtains registered user data from user database 422. More specifically, person identification system 404 obtains user data of registered users from user data portion 502 of user database 422 by accessing personal data of registered users from personal information portion 602, each entry of which includes a pointer for associated biometric parameter data of each respective registered user in biometric parameters portion 604 and a pointer for associated non-biometric parameter data of the respective registered user in non-biometric parameters portion 606.

Comparator 706 then compares the biometric parameter data of each respective registered user in biometric parameters portion 604 with the facial image of the user attempting to gain entry to the facility 100 to find a match.

If there is not a match between the facial image of the user attempting to gain entry to the facility 100 and the biometric parameter data of each respective registered user in biometric parameters portion 604, comparator 706 determines that the user attempting to gain entry to the facility 100 is not a registered user. Person identification system 404 then provides controlling component 412 with unidentified person data indicating that the user who is attempting entry into facility 100 is not a registered user.

For example, in addition to providing the controlling component 412 with an indication that the user who is attempting to enter into the facility 100 is not a register user, the unidentified person data may further include the biometric parameter data of the unidentified user, and the controlling component 412 may instructs updating system 406 to update database 402 so as to provide a record of the attempt of gaining entry to the facility 100 by the unidentified user. The record of the attempt may include the biometric parameter data of the unidentified user along with a date and time stamp indicates the day and time for which the unidentified user attempted to gain entry into facility 100.

If there is a match between the facial image of the user attempting to gain entry to the facility 100 and the biometric parameter data of each respective registered user in biometric parameters portion 604, comparator 706 then compares the non-biometric parameter data of each respective registered user in non-biometric parameters portion 606 with the RFID data associated with the RFID signal detected from the RFID tag included in the badge of the user attempting to gain entry to the facility 100 to find a match.

If there is not a match between the RFID data and the non-biometric parameter data of each respective registered user in non-biometric parameters portion 606, comparator 706 determines that the user attempting to gain entry to the facility 100 is not a registered user. Person identification system 404 then provides controlling component 412 with unidentified person data indicating that the use who is attempting entry into facility 100 is not a registered user.

For example, in addition to providing the controlling component 412 with an indication that the user who is attempting to enter into the facility 100 is not a register user, the unidentified person data may further include the non-biometric parameter data of the unidentified user, and the controlling component 412 may instructs updating system 406 to update database 402 so as to provide a record of the attempt of gaining entry to the facility 100 by the unidentified user. The record of the attempt may include the non-biometric parameter data of the unidentified user along with a date and time stamp indicates the day and time for which the unidentified user attempted to gain entry into facility 100.

If there is a match between the RFID data and the non-biometric parameter data of each respective registered user in non-biometric parameters portion 606, comparator 706 determines then if a same person is identified using the biometric parameter data and the non-biometric parameter data.

If the same person is not identified using the biometric parameter data and the non-biometric parameter data, comparator 706 determines that the user attempting to gain entry to the facility 100 is not a registered user, and person identification system 404 then provides controlling component 412 with unidentified person data indicating that the user who is attempting entry into facility 100 is not a registered user.

For example, in addition to providing the controlling component 412 with an indication that the user who is attempting to enter into the facility 100 is not a register user, the unidentified person data may further include the biometric parameter data and the non-biometric parameter data of the unidentified user, and the controlling component 412 may instructs updating system 406 to update database 402 so as to provide a record of the attempt of gaining entry to the facility 100 by the unidentified user. The records may include the biometric parameter data and the non-biometric parameter data of the unidentified user along with a date and time stamp indicates the day and time for which the unidentified user attempted to gain entry into facility 100.

If the same person is identified using the biometric parameter data and the non-biometric parameter data, comparator 706 determines that the user attempting to gain entry to the facility 100 is a registered user, and person identification system 404 then provides controlling component 412 with person identification data identifying the user who is attempting entry into facility 100.

Further, in the example described above, person identification system 404 determines the identity of the user attempting to gain access to the facility 100 using a combination of a biometric parameter and a non-biometric parameter in order to decrease the likelihood of an incorrect identification and/or spoofing of identifying information. However, it should be understood that the present disclosure is not limited by this example. For example, the person identification system 404 may only use a biometric parameter to identify the user or the person identification system 404 may only use a non-biometric parameter to identify the user. Further, the person identification system 404 may attempt to identify the user in a reverse order as that described above, that is, the person identification system 404 may first attempt to identify the user using a non-biometric parameter, and upon determining match using the non-biometric parameter, then attempt to identify the user using a biometric parameter.

At Step 804, the controlling component 412 determines if the user attempting to access the facility 100 is identified as a registered user by the person identification system 404 based on data received from the person identification system 404. For example, if the controlling component 412 receives unidentified person data indicating that the user is not a registered user, the controlling component 412 determines that the user attempting to access the facility 100 is not a registered user. Alternatively, if the controlling component 412 receives person identification data identifying the user, the controlling component 412 determines that the user attempting to access the facility 100 is a registered user.

If the controlling component determines that the user is not identified as a registered user (No at Step 804), controlling component 412 accesses warning portion 508 of user database 422 to determine what type of warning should be generated as an unidentified user warning. Controlling component 412 then instructs warning system 416 to generate the unidentified user warning indicated by warning portion 508 (Step 806). As a non-limiting example, warning system 416 may sound an audible siren and/or flashes a light to direct attention to the unidentified user and/or others near facility 100 that an unidentified user has attempted to gain entry into facility 100. Further, warning system 416 may instruct communication system 414 to send a text message, send an email, send a prerecorded telephone message to the manager of facility 100, or combinations thereof indicating that an unidentified user has attempted to gain entry into facility 100.

In this case, the unidentified user warning may warn a manager of facility 100 that an unidentified user has attempted to gain access to facility 100. The manager may then quickly take steps such as visiting the facility 100 to determine the identity of the unidentified user who has attempted to gain access or to determine why the unidentified user has attempted to gain access, or alternatively, to call the proper authorities so that they may find out such information. Accordingly, equipment management system 302 provides a security function for facility 100, thereby eliminating a need for security personnel to monitor facility 100.

Alternatively, the unapproved user warning may be generated only if the controlling component 412 determines that the unidentified user has gained entry to the facility at step 808. More specifically, in an example aspect of the present disclosure, facility entrance/exit control 304 monitors whether a person has gained entry through door 102. If facility entrance/exit control 304 detects entry of a person through door 102 into facility 100, then facility entrance/exit control 304 may inform equipment management system 302 by way of communication channel 316.

If the controlling component determines that the user is identified as a registered user (Yes at Step 804), the equipment management system 302 instructs facility entrance/exit control 304 to allow entry of the user to the facility 100 and entry of the user is registered in Step 810. For example, controlling component 412 instructs updating system 406 to update user database 422 in database 402 so as to provide a date and time stamp in the data field for the registered user, wherein the date and time stamp indicates the day and time for which the registered user has gained entry into facility 100.

According to the aspect of the present disclosure illustrated in FIG. 8, the registered user is required to undergo one or more facility procedures to demonstrate that the registered user is not impaired prior to removal or replacement of inventory. At Step 810, controlling component 412 instructs procedure confirmation system 410 to determine whether the registered user has successfully performed the one or more facility procedures.

In this regard, procedure confirmation system 410 accesses the roles data stored in roles portion 504 of user database 422 to identify one or more roles of the registered user and one or more facility procedures associated with the one of more roles of the registered user. Procedure confirmation system 410 then accesses the procedural data stored in procedure database 420 of database 402 to determine one or more actions that the registered user is required to perform and one or more conditions that must be met for each of the one or more actions in order for the one or more facility procedure to be successfully performed by the registered user.

For the purposes of description of the exemplary method illustrated in FIG. 8, the procedure confirmation system 410 accesses the roles portion 504 and the procedure database 420 and determines that the registered user is required to perform, as a facility procedure, a breathalyzer test to verify that a blood alcohol level of the registered user is below a level indicated by the procedural data stored in the procedure database 420. However, it should be understood that the present disclosure is not limited in such a manner and other known techniques of determining whether the registered user is impaired may be implemented as a facility procedure, for example, an impairing chemical level detector capable of detecting an amount of a controlled substance present in the registered user so as to determine whether the registered user is comprised by the controlled substance. An example of such a device is a breathalyzer capable of detecting Tetrahydrocannabinol, which is the psychoactive component of marijuana that causes intoxication, from the breath of the registered user.

Although the method of FIG. 8 requires the one or more facility procedures to be performed prior to removal or replacement of inventory by the registered user, it should be understood that the present disclosure is not limited in this manner, that is, it should be understood the present disclosure contemplates that the registered user may undergo the one or more facility procedures and procedure confirmation system 410 determines whether the registered user has successfully performed the one or more facility procedures at any time prior to the registered user leaving facility 100 after the registered user has gained access to the facility 100. This would ensure that registered user does not enter the work environment of the worksite while under the influence of alcohol or a controlled substance, thereby preventing a user under the influence of alcohol or a controlled substance from performing a procedure or using equipment that may create an unsafe situation for the user and/or others around the user.

It should be understood that the present disclosure contemplates that a user attempting to gain access to the facility 100 may undergo the one or more facility procedures and procedure confirmation system 410 determines whether the user has successfully performed the one or more facility procedures before the user being granted access to the facility 100. This would ensure that the user does not enter the facility 100 while under the influence of alcohol or a controlled sub stance.

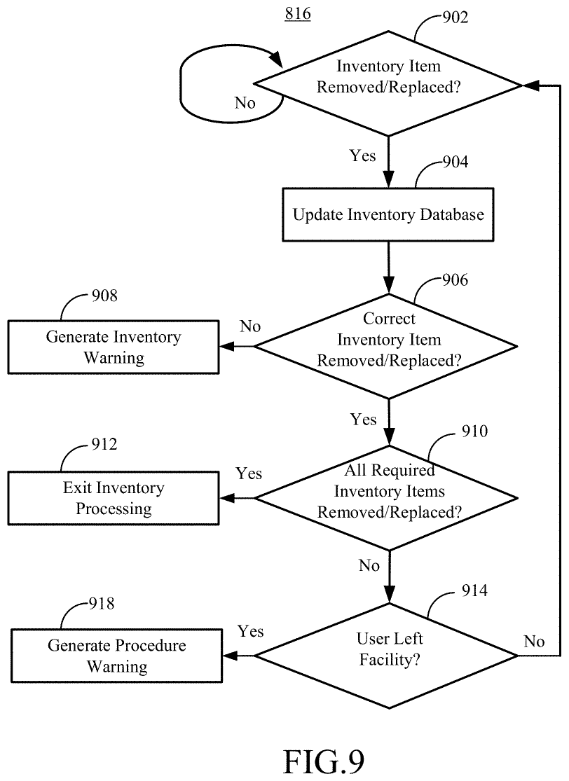

Further, if one or more inventory items are required to be removed by the registered user in order to perform the one or more facility procedures, the present disclosure contemplates that inventory processing similar to inventory processing 816, described later in detail with respect to FIG. 9, may be performed in order to ensure that the registered user removes and/or replaces a correct inventory item in order to perform the one or more facility procedures in accordance with the procedural data stored in procedure database 420 of database 402 and/or the roles data stored in roles portion 504 included in user database 422 of database 402.

If the procedure confirmation system 410 determines that the registered user has not successfully performed the required one or more facility procedures (No at Step 810), the procedure confirmation system 410 provides a signal to controlling component 412 indicating that the registered user has not successfully performed the required one or more facility procedures.

Controlling component 412 then accesses warning portion 530 of procedure database 420 to determine what type of warning should be generated as a facility procedure warning. Controlling component 412 then instructs warning system 416 to generate the facility procedure warning indicated by warning portion 530 (Step 812). As a non-limiting example, warning system 416 sounds an audible siren and/or flashes a light to direct attention to the registered user and/or others near facility 100 that the registered user has not successfully performed the required one or more facility procedures. Further, warning system 416 may instruct communication system to send a text message, send an email, send a prerecorded telephone message to the manager of facility 100 or combinations thereof, indicating that the registered user has not successfully performed the required one or more facility procedures. Accordingly, the present disclosure provides notification that the registered user has not successfully performed the required one or more facility procedures and appropriate action may be taken.

For example, the facility procedure warning may warn a manager of facility 100 that the registered user has not successfully performed the required one or more facility procedures. The manager may then quickly take steps such as contacting the registered user to find out why the registered user has not successfully performed the required one or more facility procedures.

Further, the facility procedure warning may be evidence that the registered user was warned that the required one or more facility procedures were not successfully performed. This evidence may be used to address liability issues in the event that the registered user is subsequently injured as a direct result of not having successfully performed the required one or more facility procedures.

If the procedure confirmation system 410 determines that the registered user has successfully completed the required one or more facility procedures (Yes at Step 810), the procedure confirmation system 410 provides a signal to controlling component 412 indicating that the registered user has successfully completed the required one or more facility procedures.

According to the aspect of the present disclosure illustrated in FIG. 8, facility 100 contains inventory for multiple roles. At Step 814, controlling component 412 instructs procedure confirmation system 410 to obtain post-facility procedure data for the registered user.

In this regard, procedure confirmation system 410 accesses the roles data stored in roles portion 504 of user database 422 to identify one or more roles of the registered user and one or more post-facility procedures associated with the one or more roles of the registered user. Procedure confirmation system 410 then accesses the procedural data stored in procedure database 420 of database 402 to determine the one or more post-facility procedures to be performed by the registered user after leaving the facility 100 and one or more post-facility procedure items of the inventory of items that are required for the registered user to perform the one or more post-facility procedures.

For the purposes of description of the exemplary method illustrated in FIG. 8, the procedure confirmation system 410 accesses the roles portion 504 and the procedure database 420 and determines that the registered user has a role of radiation clean-up personnel and the role of radiation cleanup personal is associated with a post-facility procedure of entering a radiation hot zone carrying a charged and operable Geiger counter. In such a case, the procedure confirmation system 410 determines, from the procedure data stored in the procedure database 420, that a post-facility procedure item required for the user to perform the post-facility procedure includes a Geiger counter.

Additionally, it should be understood that by defining the one or more post-facility procedure items of the inventory of items that are required for the registered user to perform the one or more post-facility procedures, the present disclosure is defining items of the inventory of items that the registered user is authorized to remove or replace. For example, if the registered user has a role of a janitor, the registered user may be authorized to remove a dustpan from returnable inventory rental robot unit 204; whereas if the registered user has a role of hazardous material disposal personnel, the registered user may be authorized to remove a hazardous material suit from returnable inventory rental robot unit 204.

At Step 816, controlling component 412 instructs inventory management system 408 to perform inventory processing based on the post-facility procedure data for the registered user obtained by the procedure confirmation system 410. Details of the inventory processing performed by the inventory management system 408 will be described in detail with reference to FIG. 9.

FIG. 9 illustrates an exemplary method of the inventory processing performed by the inventory management system 408 according to an aspect of the present disclosure.

At Step 902, inventory management system 408 determines whether the registered user has removed or replaced an inventory item.

More specifically, if the registered user removes an inventory item from plurality of non-returnable inventory items 210 from non-returnable inventory storage unit 306, then non-returnable inventory storage unit 306 provides a non-returnable inventory removal signal to equipment management system 302, via communication channel 312, that indicate the inventory item has been removed from non-returnable inventory storage unit 306 by the registered user and identifies the inventory item has been removed from non-returnable inventory storage unit 306 by the registered user

Similarly, if the registered user removes an inventory item from plurality of returnable inventory items 212 from returnable inventory rental robot unit 204, then rental robot controlling unit 310 provides a returnable inventory removal signal to equipment management system 302, via communication channel 314, that indicates that the inventory item has been removed from returnable inventory rental robot unit 204 by the registered user and identifies the inventory item that has been removed from returnable inventory rental robot unit 204 by the registered user.

Further, if the registered user replaces an item into returnable inventory rental robot unit 204, then rental robot controlling unit 310 provides a returned inventory signal to equipment management system 302, via communication channel 314, that indicates that the inventory item has been replaced in returnable inventory rental robot unit 204 by the registered user and identifies the inventory item that has been replaced in returnable inventory rental robot unit 204 by the registered user.

Accordingly, any non-returnable inventory removal signal from non-returnable inventory storage unit 306, returnable inventory removal signal from rental robot controlling unit 310, or returned inventory signal from rental robot controlling unit 310 indicates removal or replacement of an inventory item.

Communication system 414 receives any non-returnable inventory removal signal from non-returnable inventory storage unit 306, returnable inventory removal signal from rental robot controlling unit 310 or returned inventory signal from rental robot controlling unit 310. Any of these received signals are then provided to controlling component 412.

Controlling component 412 then provides any received non-returnable inventory removal signal, returnable inventory removal signal, or returned inventory signal to inventory management system 408. Based on the any of the signals, inventory management system 408 is able to determine that the registered user has removed or replaced an item of the inventory of items (Yes at Step 902) and instruct inventory updating system 426 to update inventory database 418 (Step 904) based on the received signal.

If the controlling component 412 has not received a signal indicating removal or return of an inventory item, inventory management system 408 determines that the registered user has not yet removed or replaced an item of the inventory of items (No at Step 902). As a result, the inventory processing will remain at Step 902 until a determination that the registered user has removed or replaced an item of the inventory of items.

After the inventory database 418 has been updated (Step 904), inventory management system 408 determines whether the correct inventory has been removed or replaced based on the post-facility procedure data for the registered user obtained by the procedure confirmation system 410 (Step 906).

By determining whether the correct inventory has been removed, the present disclosure ensures that the registered user is properly equipped for a post-facility procedure that the registered user will perform at the worksite, thereby preventing the registered user from creating an unsafe worksite for the registered user and/or others around the registered user as a result of using incorrect equipment for the post-facility procedure. Additionally, determining whether the correct inventory has been replaced, the present disclosure ensures that the registered user has properly returned equipment after performing a post-facility procedure at the worksite, thereby preventing unexpected loss of equipment.

In this regard, as discussed above, inventory management system 408 determines one or more post-facility procedure to be performed by the registered user after leaving the facility 100 and one or more post-facility procedure items of the inventory of items that is required for the registered user to perform the one or more post-facility procedures.

Based on post-facility procedure data for the registered user obtained by the procedure confirmation system 410, inventory management system 408 compares (i) any non-returnable inventory removal signal from non-returnable inventory storage unit 306, returnable inventory removal signal from rental robot controlling unit 310, or returned inventory signal from rental robot controlling unit 310 indicating removal or replacement of an inventory item and identifying the inventory item to (ii) the one or more post-facility procedure items that are required for the registered user to perform the one or more post-facility procedures to determine whether the correct inventory item has been removed or replaced.

If the inventory item indicated and identified by any non-returnable inventory removal signal from non-returnable inventory storage unit 306, returnable inventory removal signal from rental robot controlling unit 310, or returned inventory signal from rental robot controlling unit 310 matches an inventory item from among the one or more post-facility procedure items that are required for the registered user to perform the one or more post-facility procedures, then inventory identification system 424 determines that the correct inventory item has been removed or replaced (Yes at Step 906).

Alternatively, if the inventory item indicated and identified by any non-returnable inventory removal signal from non-returnable inventory storage unit 306, returnable inventory removal signal from rental robot controlling unit 310, or returned inventory signal from rental robot controlling unit 310 does not match an inventory item from among the one or more post-facility procedure items that are required for the registered user to perform the one or more post-facility procedures, then inventory identification system 424 determines that the correct inventory item has been not removed or replaced (No at Step 906).

If inventory identification system 424 determines that the correct inventory item has not been removed or replaced (No at Step 906), the inventory identification system 424 provides an incorrect inventory signal to controlling component 412 indicating that the registered user has not removed or replaced the correct inventory item.

Controlling component 412 then accesses warning portion 428 of inventory database 418 to determine what type of warning should be generated as an inventory warning. Controlling component 412 then instructs warning system 416 to generate the inventory warning indicated by warning portion 428 (Step 908). As a non-limiting example, warning system 416 sounds an audible siren and/or flashes a light to direct attention to the registered user and/or others near facility 100 that the registered user has not removed or replaced the correct inventory item. Further, warning system 416 may instruct communication system to send a text message, send an email, send a prerecorded telephone message to the manager of facility 100, or combinations thereof, indicating that the registered user has not removed or replaced the correct inventory item. Accordingly, the present disclosure is able to provide notification that the registered user has not removed or replaced the correct inventory item and appropriate action may be taken.

For example, the inventory warning may warn a manager of facility 100 the registered user has not removed or replaced the correct inventory item. The manager may then quickly take steps such as contacting the registered user to find out why the registered user has not removed or replaced the correct inventory item. The inventory warning may, therefore, reduce the likelihood of employee theft.

Further, in the event that the registered user is confused or has erred with respect to a post-facility procedure that is needed to be performed, this confusion or error may be highlighted as a result of the incorrect inventory item having been removed. In such a case, the manager of facility 100 may quickly contact the registered user and address the confusion or error before the user incorrectly performs the post-facility procedure or before the registered user performs an incorrect post-facility procedure.

If inventory identification system 424 determines that the correct inventory has been removed or replaced (Yes at Step 906), the inventory identification system 424 then determines if all required inventory items have been removed or replaced based on the one or more post-facility procedure items that are required for the registered user to perform the one or more post-facility procedures included in the post-facility procedure data for the registered user obtained by the procedure confirmation system 410 (Step 910).

By determining whether all required inventory items have been removed, the present disclosure advantageously ensures that the registered user is properly equipped for a post-facility procedure that the registered user will perform at the worksite, thereby preventing the registered user from creating an unsafe situation for the registered user and/or others around the registered user as a result of using incorrect equipment for the post-facility procedure. For example, some of the post-facility procedure may require different types of equipment for the users to properly accomplish the assigned work in an efficient and safe manner, including operating equipment, safety equipment, and other equipment for monitoring the working environment as well as for communications, lighting and energy. The present disclosure not only advantageously ensures each of the inventory item has been correctly removed by the user, but also ensures all required inventory items have been completely assigned to and removed by the user in accordance with the post-facility procedures associated with the registered user and the assigned work. Additionally, by determining whether all required inventory items have been replaced, the present disclosure ensures that the registered user has properly returned all equipment after performing a post-facility procedure at the worksite, thereby preventing unexpected loss of equipment.

If inventory identification system 424 determines that all required inventory items have been removed or replaced for performing the one or more post-facility procedures included in the post-facility procedure data for the registered user obtained by the procedure confirmation system 410 (Yes at Step 912), inventory processing 816 is complete (Step 912).

If inventory identification system 424 determines that all required inventory items have not been removed or replaced for performing the one or more post-facility procedures included in the post-facility procedure data for the registered user obtained by the procedure confirmation system 410 (No at Step 912), inventory identification system 424 makes a determination as to whether the registered user has left the facility 100 (Step 914).

More specifically, as noted above, facility entrance/exit control 304 monitors whether a person has gained entry through door 102, and if facility entrance/exit control 304 detects entry of a person through door 102 into facility 100, then facility entrance/exit control 304 may inform equipment management system 302 by way of communication channel 316. Accordingly, inventory identification system 424 may determine whether the registered user has left the facility based on a signal received the facility entrance/exit control 304.

If inventory identification system 424 determines that the registered user has left the facility 100, the inventory identification system 424 provides a post-facility procedure warning signal to controlling component 412 indicating that the registered user has left the facility 100 without removing or replacing all required inventory items for performing the one or more post-facility procedures included in the post-facility procedure data for the registered user obtained by the procedure confirmation system 410.

By determining whether the registered user has left the facility 100, the present disclosure is able to make a determination as to whether the registered user is properly equipped for a post-facility procedure that the registered user will perform at the worksite, thereby preventing the registered user from creating an unsafe worksite for the registered user and/or others around the registered user as a result of using incorrect equipment for the post-facility procedure. Additionally, determining whether the registered user has left the facility 100, the present disclosure is able to make a determination as to whether the registered user has properly returned all equipment after performing a post-facility procedure at the worksite, thereby preventing unexpected loss of equipment.

Controlling component 412 then accesses warning portion 430 of procedure database 420 to determine what type of warning should be generated as a post-facility procedure warning. Controlling component 412 then instructs warning system 416 to generate the post-facility procedure warning indicated by warning portion 430 (Step 918). As a non-limiting example, warning system 416 sounds an audible siren and/or flashes a light to direct attention to the registered user and/or others near facility 100 that the registered user has left facility 100 without removing or replacing all required inventory items. Further, warning system 416 may instruct communication system to send a text message, send an email, send a prerecorded telephone message to the manager of facility 100, or combinations thereof, indicating that the registered user has left facility 100 without removing or replacing all required inventory items. Accordingly, the present disclosure is able to provide notification that the registered user has left facility 100 without removing or replacing all required inventory items and appropriate action may be taken.

For example, the manager of facility 100 may be warned that the registered user has left facility 100 without being appropriately prepared to perform one or more post-facility procedures outside facility 100. The manager may then take necessary steps, such as contacting the person to determine why the registered user left facility 100 without being appropriately prepared to perform one or more post-facility procedures outside facility 100 or to instruct the registered user not to attempt to perform the one or more post-facility procedures until the registered user returns to facility 100 and retrieves the appropriate inventory items.

If inventory identification system 424 determines the that user has not left the facility 100, inventory processing 816 is repeated by returning to step 902, where inventory management system 408 determines whether the registered user has removed or replaced an item of the inventory of items.

It should be understood that if one or more inventory items are required to be removed by the registered user in order to perform the one or more facility procedures described above with respect to FIG. 8, the present disclosure contemplates that the above processing illustrated by FIG. 9 may be modified such that inventory identification system 424 determines whether a correct of item inventory has been removed or replaced and whether all required inventory items have been removed or replaced based on one or more inventory items that are required for the registered user to perform the one or more facility procedures in accordance with the procedural data stored in procedure database 420 of database 402 and/or the roles data stored in roles portion 504 included in user database 422 of database 402.

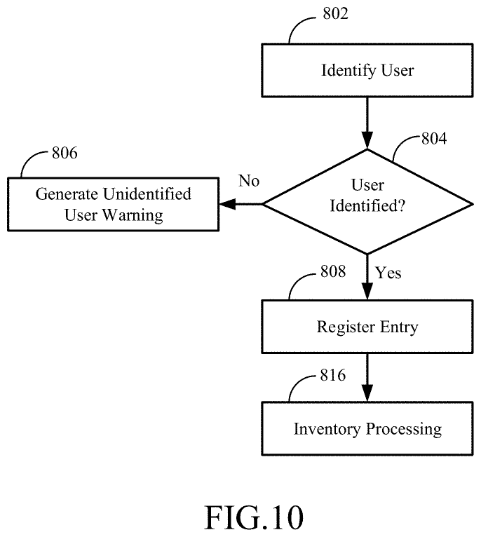

FIG. 10 illustrates an exemplary method for managing equipment using the equipment management system 302 according to an aspect of the present disclosure. The aspect of the present disclosure illustrated in FIG. 10 contemplates that facility 100 stores a single inventory item corresponding to a single type of post-facility procedure to be performed. Additionally, the method of FIG. 10 does not require a user who has gained access to the facility 100 to undergo a facility procedure to demonstrate the user is not impaired prior to removal or replacement of inventory. Accordingly, the method of FIG. 10 is the same as the exemplary method of FIG. 8 described in detail above except that steps 810, 812, and 814 are not performed.

The aspect of the present disclosure illustrated in FIG. 10 is useful is situations where the equipment management system 302 is incorporated into a facility 100 that is temporarily deployed to a worksite where a single procedure is to be performed, thus requiring only one inventory item is required to be stored in facility 100.

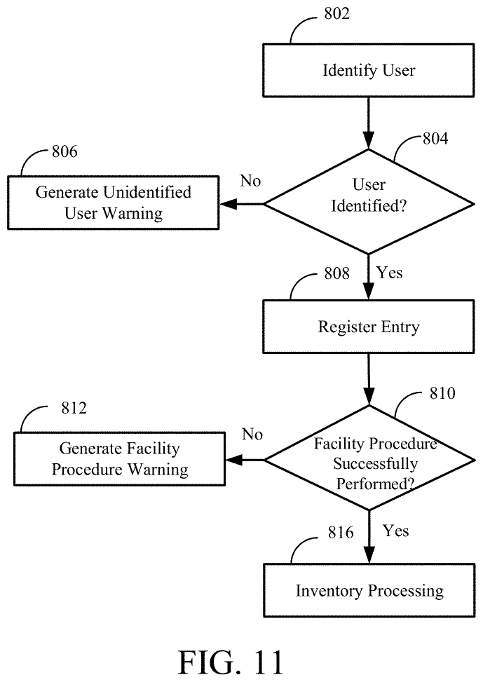

FIG. 11 illustrates an exemplary method for managing equipment using the equipment management system 302 according to an aspect of the present disclosure. The aspect of the present disclosure illustrated in FIG. 11 contemplates that facility 100 stores a single type of inventory corresponding to a single type of post-facility procedure to be performed. Additionally, the method of FIG. 11 requires a user who has gained access to the facility 100 to undergo a facility procedure to demonstrate the user is not impaired prior to removal or replacement of inventory. Accordingly, the method of FIG. 11 is the same as the exemplary method of FIG. 8 described in detail above except that step 814 is not performed.

The aspect of the present disclosure illustrated in FIG. 11 is useful in situations where the equipment management system 302 is incorporated into a facility 100 that is temporarily deployed to a worksite where a single procedure is to be performed, thus requiring only one inventory item is required to be stored in facility 100, and where the single procedure to be performed warrants impairment detection of the user.

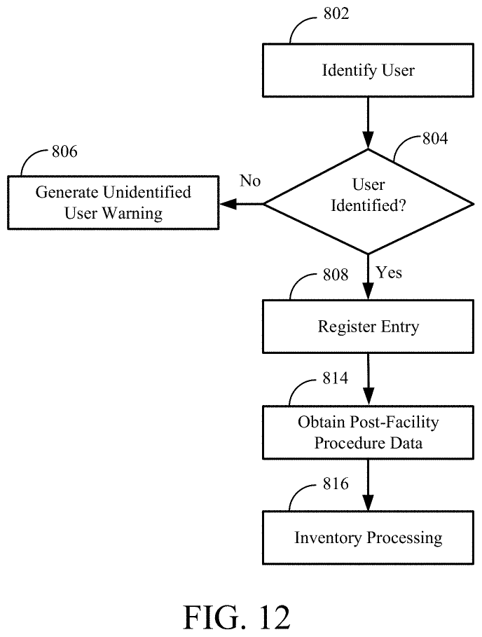

FIG. 12 illustrates an exemplary method for managing equipment using the equipment management system 302 according to an aspect of the present disclosure. The aspect of the present disclosure illustrated in FIG. 12 contemplates that facility 100 stores different types of inventory corresponding to different types of post-facility procedures to be performed. Additionally, the method of FIG. 12 does not require a user who has gained access to the facility 100 to undergo a facility procedure to demonstrate the user is not impaired prior to removal or replacement of inventory. Accordingly, the method of FIG. 12 is the same as the exemplary method of FIG. 8 described in detail above except that steps 810 and 812 are not performed.

The aspect of the present disclosure illustrated in FIG. 12 is useful in situations where the equipment management system 302 is incorporated into a facility 100 that is permanently or temporarily deployed to a worksite where multiple procedures are required to be performed.

The present disclosure may be implemented as any combination of an apparatus, a system, an integrated circuit, and a computer program on a non-transitory computer-readable recording medium. The microcontrollers may be implemented as an integrated circuit (IC), an application-specific integrated circuit (ASIC), or large-scale integrated circuit (LSI), system LSI, super LSI, or ultra LSI components which perform a part or all of the functions of the wireless ECG module and main module.

Each of the components of the present disclosure can be implemented using many single-function components, or can be one component integrated using the technologies described above. The various illustrative circuits and modules described in connection with the disclosure herein may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration. A processor may in some cases be in electronic communication with a memory, where the memory stores instructions that are executable by the processor.

The subject matter of the disclosure of the present application is merely provided as examples of a system for managing equipment. Further features or variations are contemplated in addition to the features of the system for managing equipment described above. It is contemplated that the implementation of the components of the present disclosure can be done with any newly arising technology that may replace any of the above-implemented technologies.

The above description provides examples, and is not limiting of the scope, applicability, or configuration set forth in the claims. Changes may be made in the function and arrangement of elements discussed without departing from the spirit and scope of the disclosure. Various aspects of the disclosure may omit, substitute, or add various procedures or components as appropriate. For instance, features described with respect to certain aspects of the disclosure may be combined in other aspects of the disclosure.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” indicates an example or instance and does not imply or require any preference for the noted example. Thus, the disclosure is not to be limited to the examples and designs described herein but is to be accorded the widest scope consistent with the principles and novel features disclosed herein.

The foregoing description of various aspects of the disclosure have been presented for purposes of illustration and description. It is not intended to be exhaustive or to limit the invention to the precise forms disclosed, and obviously many modifications and variations are possible in light of the above teaching. The exemplary aspects of the disclosure, as described above, were chosen and described in order to best explain the principles of the invention and its practical application to thereby enable others skilled in the art to best utilize the aspects of the disclosure and with various modifications as are suited to the particular use contemplated. It is intended that the scope of the aspects of the disclosure be defined by the claims appended hereto.

1. An equipment management system for use in a facility having an inventory of items, said system comprising:
an inventory database operable to have inventory data stored therein, the inventory data corresponding to the items of the inventory;
a user database operable to have user data stored therein, the user data corresponding to an identity of a user;
a person identification system operable generate a user identification signal based on a detected biometric parameter of the user and based on a detected non-biometric parameter associated with the user; and
an inventory management system operable generate an inventory identification signal based on a determination as to whether the user has removed an item of the inventory of items.

2. The system of claim 1, wherein said inventory management system is further operable to update said inventory database when the user has removed the item of the inventory of items.

3. The system of claim 1, further comprising:
a procedure database operable to have procedural data stored therein, the procedural data corresponding to a facility procedure to be performed by the user prior to leaving the facility;
a procedure confirmation system operable generate a facility procedure confirmation signal based on a determination as to whether the facility procedure has been performed by the user.

4. The system of claim 3, further comprising a warning system operable to generate at least one warning selected from the group of warnings including an unapproved user warning based on the user identification signal, a facility procedure failure warning based on the facility procedure confirmation signal and an inventory warning based on the inventory identification signal.

5. The system of claim 3, wherein said procedure confirmation system comprises an impairing chemical level detector operable to detect an amount of an impairing chemical present in the user.

6. The system of claim 1, further comprising:
a procedure database operable to have procedural data stored therein, the procedural data corresponding to a post-facility procedure to be performed by the user after leaving the facility and to a post-facility procedure item of the inventory of items that is required for the user to perform the post-facility procedure; and
a procedure confirmation system operable generate a post-facility procedure confirmation signal based on a determination as to whether the user has removed the post-facility procedure item.

7. The system of claim 1,
wherein said person identification system comprises a biometric detector operable to detect, as the detected biometric parameter of the user, at least one biometric parameter selected from the group of biometric parameters including a fingerprint, a hand print, a face image, a vocal sample, an iris image and a fundus image, and
wherein said person identification system further comprises a radio frequency identification system operable to detect, as the detected non-biometric parameter associated with the user, a radio frequency identification tag associated with the user.

8. A method of an equipment management system for use in a facility having an inventory of items, said method comprising:
storing, in an inventory database, inventory data corresponding to the items of the inventory;
storing, in a user database, user data corresponding to an identity of a user;
detecting, via a person identification system, a detected biometric parameter of the user;
detecting, via the person identification system, a detected non-biometric parameter associated with the user;
generating, via the person identification system, a user identification signal based on the detected biometric parameter of the user and based on the detected non-biometric parameter associated with the user;
determining, via an inventory management system, whether the user has removed an item of the inventory of items; and
generating, via the inventory management system, an inventory identification signal based on the determination as to whether the user has removed the item of the inventory of items.

9. The method of claim 8, further comprising updating, via the inventory management system, the inventory database when the user has removed the item of the inventory of items.

10. The method of claim 8, further comprising:
storing, in a procedure database, procedural data corresponding to a facility procedure to be performed by the user prior to leaving the facility;
determining, via a procedure confirmation system, whether the facility procedure has been performed by the user; and
generating, via the procedure confirmation system, a facility procedure confirmation signal based on the determination as to whether the facility procedure has been performed by the user.

11. The method of claim 10, further comprising generating, via a warning system, at least one warning selected from the group of warnings including an unapproved user warning based on the user identification signal, a facility procedure failure warning based on the facility procedure confirmation signal and an inventory warning based on the inventory identification signal.

12. The method of claim 10, wherein said determining, via the procedure confirmation system, whether the facility procedure has been performed by the user comprises determining, via an impairing chemical level detector operable to detect an amount of an impairing chemical present in the user, whether the amount of the impairing chemical present in the user is above a predetermined threshold.

13. The method of claim 8, further comprising:
storing, in a procedure database, procedural data corresponding to a post-facility procedure to be performed by the user after leaving the facility and to a post-facility procedure item of the inventory of items that is required for the user to perform the post-facility procedure;
determining, via a procedure confirmation system, whether the user has removed the post-facility procedure item; and
generating, via the procedure confirmation system, a post-facility procedure confirmation signal based on the determination as to whether the user has removed the post-facility procedure item.

14. The method of claim 8, wherein said generating, via the person identification system, the user identification signal based on the detected biometric parameter of the user and based on the detected non-biometric parameter associated with the user comprises detecting, via a biometric detector operable to detect as the detected biometric parameter of the user, at least one biometric parameter selected from the group of biometric parameters including a fingerprint, a hand print, a face image, a vocal sample, an iris image and a fundus image and detecting, via a radio frequency identification system operable to detect as the detected non-biometric parameter associated with the user, a radio frequency identification tag associated with the user.

15. A non-transitory, tangible, computer-readable media having computer-readable instructions stored thereon, for use with a computer, for use with an equipment management system in a facility having an inventory of items and being capable of instructing the computer to perform a method comprising:
storing, in an inventory database, inventory data corresponding to the items of the inventory;
storing, in a user database, user data corresponding to an identity of a user;
detecting, via a person identification system, a detected biometric parameter of the user;
detecting, via the person identification system, a detected non-biometric parameter associated with the user;
generating, via the person identification system, a user identification signal based on the detected biometric parameter of the user and based on the detected non-biometric parameter associated with the user;
determining, via an inventory management system, whether the user has removed an item of the inventory of items; and
generating, via the inventory management system, an inventory identification signal based on the determination as to whether the user has removed the item of the inventory of items.

16. The non-transitory, tangible, computer-readable media of claim 15, the computer-readable instructions stored thereon being capable of instructing the computer to perform the method further comprising updating, via the inventory management system, the inventory database when the user has removed the item of the inventory of items.

17. The non-transitory, tangible, computer-readable media of claim 15, the computer-readable instructions stored thereon being capable of instructing the computer to perform the method further comprising:
storing, in a procedure database, procedural data corresponding to a facility procedure to be performed by the user prior to leaving the facility;
determining, via a procedure confirmation system, whether the facility procedure has been performed by the user; and
generating, via the procedure confirmation system, a facility procedure confirmation signal based on the determination as to whether the facility procedure has been performed by the user.

18. The non-transitory, tangible, computer-readable media of claim 17, the computer-readable instructions stored thereon being capable of instructing the computer to perform the method further comprising generating, via a warning system, at least one warning selected from the group of warnings including an unapproved user warning based on the user identification signal, a facility procedure failure warning based on the facility procedure confirmation signal and an inventory warning based on the inventory identification signal.

19. The non-transitory, tangible, computer-readable media of claim 17, the computer-readable instructions stored thereon being capable of instructing the computer to perform the method wherein said determining, via the procedure confirmation system, whether the facility procedure has been performed by the user comprises determining, via an impairing chemical level detector operable to detect an amount of an impairing chemical present in the user, whether the amount of the impairing chemical present in the user is above a predetermined threshold.

20. The non-transitory, tangible, computer-readable media of claim 15, the computer-readable instructions stored thereon being capable of instructing the computer to perform the method further comprising:
storing, in a procedure database, procedural data corresponding to a post-facility procedure to be performed by the user after leaving the facility and to a post-facility procedure item of the inventory of items that is required for the user to perform the post-facility procedure;
determining, via a procedure confirmation system, whether the user has removed the post-facility procedure item; and
generating, via the procedure confirmation system, a post-facility procedure confirmation signal based on the determination as to whether the user has removed the post-facility procedure item.

21. The non-transitory, tangible, computer-readable media of claim 15, the computer-readable instructions stored thereon being capable of instructing the computer to perform the method wherein said generating, via the person identification system, the user identification signal based on the detected biometric parameter of the user and based on the detected non-biometric parameter associated with the user comprises detecting, via a biometric detector operable to detect as the detected biometric parameter of the user, at least one biometric parameter selected from the group of biometric parameters including a fingerprint, a hand print, a face image, a vocal sample, an iris image and a fundus image and detecting, via a radio frequency identification system operable to detect as the detected non-biometric parameter associated with the user, a radio frequency identification tag associated with the user.
